(19) United States
(12) Patent Application Publication
(10) Pub. No.: US 2023/0231181 A1
(43) Pub. Date: Jul. 20, 2023

(54) Inorganic-Polymeric Hybrid Solid-State Electrolytes, Lithium Batteries Containing Same, and Production Processes

(71) Applicant: Global Graphene Group, Inc., Dayton, OH (US)

(72) Inventors: Aruna Zhamu, Springboro, OH (US); Bor Z. Jang, Centerville, OH (US)

(73) Assignee: Global Graphene Group, Inc., Dayton, OH (US)

(21) Appl. No.: 17/648,167

(22) Filed: Jan. 17, 2022

(51) Int. Cl. H01M 10/056; H01M 10/0525; H01M 4/62; H01M 4/525; H01M 4/505; C08F 124/00; C08F 112/14

(52) U.S. Cl. CPC H01M 10/056; H01M 10/0525; H01M 4/62; H01M 4/525; H01M 4/505; C08F 124/00; C08F 112/30; H01M 2300/0094

(57) ABSTRACT

A hybrid solid electrolyte particulate (or multiple particulates) for use in a rechargeable lithium battery cell, wherein the particulate comprises one or more than one inorganic solid electrolyte particles encapsulated by a shell of polymer electrolyte wherein the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10^{31 6} S/cm. Also provided is a lithium-ion or lithium metal cell containing multiple hybrid solid electrolyte particulates in the anode, cathode and/or the separator. Processes for producing hybrid solid electrolyte particulates are also disclosed.

### FIELD

The present invention provides a fire/flame-resistant hybrid electrolyte and lithium batteries (lithium-ion and lithium metal batteries) containing such an electrolyte. The electrolytes can be implemented in an anode (negative electrode), a cathode (positive electrode), and/or a separator in a battery cell.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the liquid electrolytes used for all lithium-ion batteries and all lithium metal secondary batteries pose some safety concerns. Most of the organic liquid electrolytes can cause thermal runaway or explosion problems. To mitigate these risks, one can replace organic liquid electrolytes with inorganic solid electrolytes, which feature higher thermal stability and are not susceptible to leakage. This replacement affords high-energy-density all-solid-state batteries (ASSBs), which have attracted much attention, as exemplified by many recent attempts to use solid electrolytes in combination with high-voltage cathodes, high-capacity sulfur electrodes, and Li metal anodes for improved energy densities and safety.

Solid state electrolytes are commonly believed to he safe in terms of fire and explosion proof. Solid state electrolytes can be divided into organic (polymeric), inorganic, organic-inorganic composite electrolytes. However, the lithium-ion conductivity of well-known organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵S/cm) although there are solid polymeric electrolytes that exhibit higher conductivity.

Although the inorganic solid-state electrolyte (e.g., garnet-type and metal sulfide-type) can exhibit a high conductivity (from 5×10⁻⁵ to 10⁻²S/cm), the interfacial impedance or resistance between the inorganic solid-state electrolyte and the electrode (cathode or anode) is high, often leading to unsatisfactory power densities. Further, the traditional inorganic ceramic electrolyte is very brittle and has poor film-forming ability and poor mechanical properties. Furthermore, many of these materials cannot be cost-effectively manufactured into a thin separator.

Among the various types of inorganic solid electrolytes (e.g., sulfide-, oxide-, hydride-, and halide-based) developed to date, the sulfide-based ones feature high conductivities and interface formability, and are therefore particularly well suited for ASSBs. In particular, sulfide electrolytes with Li₁₀GeP₂S12, argyrodite, and Li₇P₃S₁₁-type crystal structures have high conductivities (>10⁻³ S/cm and some >10₋₂ S/cm), comparable to those of liquid electrolytes. Sulfide electrolytes are easily deformed by pressing at room temperature, allowing one to form favorable electrode/electrolyte interfaces with high contact areas, and ensure sufficient ion conduction. However, processing of sulfide electrolyte-based electrodes and separators using the common slurry coating process can involve emission of undesirable chemical species (e.g., toxic hydrogen sulfide). Further, the volume changes of the electrode active materials during charge/discharge tend to induce local contact losses at the electrode/electrolyte interfaces in an ASSB.

Another serious drawback of implementing the inorganic solid electrolyte (ISE) in an electrode (anode or cathode) is the notion that it would normally take a high loading of the ISE particles (typically 30-60% by volume) to meet the two essential conditions: (i) the electrolyte must form a contiguous phase through which lithium ions can travel to reach individual particles of an electrode (anode or cathode) active material; and (ii) substantially each and every electrode active material particle (e.g., graphite or Si particles in the anode or lithium metal oxide particles in the cathode) must be in physical contact with this contiguous electrolyte phase. This implies that the proportion of the electrode active material responsible for the lithium ion storage capability in an electrode would be reduced to less than 40-70%, leading to a significantly reduced energy density of the resulting battery cell. It is thus essential to minimize the amounts of the electrolyte and other non-active materials, such as conductive filler and binder, in an electrode.

The most series issue associated with certain solid-state electrolytes (e.g., sulfide solid-state electrolytes, SSEs) is the observation that these electrolytes have a narrow electrochemical stability window when compared with oxides and halides. Such a narrow electrochemical stability window is a major practical disadvantage of sulfide SSEs since the electrolyte must be stable over a wide range of lithium potentials between the anode chemical potential (0 eV/atom vs. Li/Li⁺) and the potential set by the cathode, which is near 4.0 eV/atom vs. Li/Li⁺ for some typical cathode active materials.

Hence, a general object of the present invention is to provide a safe, flame/fire-resistant, solid-state electrolyte system for a rechargeable lithium cell that overcomes most or all of the aforementioned issues. Desirably, the electrolyte is also compatible with existing battery production facilities. It is a further object of the present invention to provide an electrolyte that occupies a minimal proportion of the total volume of an electrode, yet still forms a contiguous phase in the electrode and is in physical contact with substantially all the electrode active material particles.

### SUMMARY

The present disclosure provides a hybrid solid electrolyte particulate (or multiple particulates) for use in a rechargeable lithium battery cell, wherein the particulate comprises one or more than one particles of an inorganic solid electrolyte (ISE) encapsulated by a shell of polymer electrolyte wherein (i) the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10⁻⁶ S/cm and (ii) the polymer electrolyte-to inorganic solid electrolyte ratio is from 1/100 to 100/1 or the polymer electrolyte shell has a thickness from 1 nm to 10 μm. The encapsulating polymer shell preferably has a thickness from 1 nm to 10 μm (preferably from 2 nm to 2 μm, more preferably less than 1 μm, and most preferably less than 500 nm). In certain embodiments, the inorganic solid electrolyte material particles are preferably from 5 nm to 20 μm in diameter, more preferably from 20 nm to 10 μm, and most preferably smaller than 5 μm).

Also provided is a lithium-ion or lithium metal cell containing multiple hybrid solid electrolyte particulates in the anode, cathode and/or the separator.

Preferably, the hybrid electrolyte particle has a lithium-ion conductivity from 10⁻⁵ S/cm to 5×10⁻² S/cm. Preferably, the polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, further more preferably greater than 10⁴ S/cm, and most preferably greater than 10⁻³ S/cm.

In certain embodiments, the inorganic solid electrolyte material is selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

In certain embodiments, the polymer electrolyte in the encapsulating shell comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polysilane, polyalkyl siloxane (e.g., polydimethylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a chemical derivative thereof, a copolymer thereof, a sulfonated derivative thereof, or a combination thereof.

In some preferred embodiments, the polymer electrolyte shell further comprises a lithium salt (e.g., 0.1% -60% by weight of a lithium salt dispersed in the polymer electrolyte).

In some embodiments, the rechargeable lithium cell has the following features:
1) the hybrid solid electrolyte particulates comprise a 1^{st} solid electrolyte polymer encapsulating inorganic solid electrolyte particles;
2) the anode comprises multiple anode particulates comprising anode active material particles encapsulated by a 2^{nd} solid electrolyte polymer, wherein the 1^{st} solid electrolyte polymer and the 2^{nd} solid electrolyte polymer are identical or different in chemical composition or structure; and
3) the hybrid solid electrolyte particulates and the anode particulates, along with an optional conductive additive, are compacted or consolidated to form the anode, wherein the 1^{st} solid electrolyte polymer and the 2^{nd} solid electrolyte polymer form a contiguous pathway for lithium ion transport.

The present disclosure also provides an anode that has the above defined features.

In some embodiments, the rechargeable lithium cell has the following features:
1) the hybrid solid electrolyte particulates comprise a 1^{st} solid electrolyte polymer encapsulating inorganic solid electrolyte particles;
2) the cathode comprises multiple cathode particulates each comprising cathode active material particles encapsulated by a 2^{nd} solid electrolyte polymer, wherein the 1^{st} solid electrolyte polymer and the 2^{nd} solid electrolyte polymer are identical or different in chemical composition or structure; and
3) the hybrid solid electrolyte particulates and the cathode particulates, along with an optional conductive additive, are compacted or consolidated to form the cathode, wherein the 1^{st} solid electrolyte polymer and the 2^{nd} solid electrolyte polymer, in combination, form a contiguous pathway for lithium ion transport.

The present disclosure also provides a cathode that has the above defined features.

The processes that can be used to produce the hybrid solid electrolyte particulates are briefly described now, and they will be further discussed later. For instance, for those polymers that are soluble in a liquid solvent (e.g., linear-chain or branched polymers), one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (polymer electrolyte-encapsulated ISE secondary particles) using any known particle-forming procedure combined with solvent removal (e.g., spray-drying).

In some other examples, the polymer electrolyte as the encapsulating shell in the hybrid solid electrolyte particulate comprises a polymer that is a polymerization or crosslinking product of a reactive additive comprising (i) a first liquid solvent that is polymerizable and/or cross-linkable, (ii) an initiator and/or curing agent, and (iii) a lithium salt (optional but desirable), wherein the first liquid solvent occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the polymerizable first liquid solvent is polymerized; more preferably >50%, further preferably >70%, and most preferably >99% is polymerized.

In certain embodiments, the first liquid solvent comprises a polymerizable/cross-linkable liquid selected from the group consisting of vinylene carbonate, ethylene carbonate, fluoroethylene carbonate, ethylene glycol phenyl ether acrylate) (PEGPEA), ethoxylated trimethyl propyl triacrylate (ETPTA), tetrahydrofuran (THF), vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones (including alkyl siloxanes, etc.), sulfides, dinitriles, acrylonitrile (AN), sulfates, siloxanes, silanes, N-methylacetamide, acrylates, ethylene glycols, phosphates, phosphonates, phosphinates, phosphines, phosphine oxides, phosphonic acids, phosphorous acid, phosphites, phosphoric acids, phosphazene compounds, derivatives thereof, and combinations thereof.

In the conventional lithium-ion battery or lithium metal battery industry, the organic liquid solvents listed above are commonly used as a solvent to dissolve a lithium salt therein and the resulting solutions are used as a liquid electrolyte. These liquid solvents are capable of dissolving a high amount of a lithium salt; however, many of them are highly volatile, having a low flash point and being highly flammable. Further, these liquid solvents are generally not known to be polymerizable.

It is uniquely advantageous to be able to fully polymerize the liquid solvent once the liquid electrolyte (having a lithium salt dissolved in the first liquid solvent that is initially in an oligomer, partially polymerized, or partially crosslinked state) is used to form a shell that embraces and encapsulating single or multiple inorganic solid electrolyte (ISE) particles. The hybrid solid electrolyte particulates (secondary particles) can then be utilized in the anode, the cathode, and/or the separator. Multiple hybrid solid electrolyte particulates may be formed (e.g., melt fusion followed by solidification) into an ion-conducting membrane as a separator, preferably having a thickness from 10 nm to less than 100 μm. Multiple hybrid solid electrolyte particulates may also be mixed with a desired amount of an anode active material (e.g., graphite, Si, SiO particles) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, separator, and cell:
1) no liquid electrolyte leakage issue in a battery cell;
2) adequate amount of lithium salt dispersed in the polymer electrolyte shell to impart a good lithium-ion conductivity to the polymer shell;
3) good lithium-ion conductivity of the all-solid hybrid electrolyte particles;
4) eliminated flammability of the battery cell;
5) good mixing of the electrolyte particles with the anode or cathode active material particles, enabling significantly reduced interfacial impedance and improved utilization of the active material (hence, higher energy density); and
6) processing ease, including compatibility with current lithium-ion battery production processes and equipment.

These features provide significant utility value since most of the organic solvents commonly used in the lithium battery are known to be volatile and flammable, posing a fire and explosion danger. Further, current solid-state electrolytes are not compatible with existing lithium-ion battery manufacturing equipment and processes.

The first polymerizable liquid solvent may comprise an ionic liquid. The ionic liquid may be selected from the group consisting of room temperature ionic liquids having a cation selected from tetraalkylammonium, di-, tri-, or tetra-alkylimidazolium, alkylpyridinium, dialkyl-pyrrolidinium, dialkylpiperidinium, tetraalkylphosphonium, hexakis(bromomethyl)benzene, and trialkylsulfonium, 1-vinyl-3-dodecyl imidazolium bis(trifluoromethanesulfonyl) imide (VDIM-TFSI) or 1-vinyl-3-methylimidazolium bis[(trifluoromethyl)sulfonyl]imide (VMIMTFSI), 1-ethyl-3-methylimidazolium bis(trifluoromethanesulfonyl) imide (EMITFSI), [(poly(diallyldimethyl ammonium bis(fluorosulfonyl)imide, (C₁₀H₁₆F₂N₂O₄S₂)n, vinylimidazolium monomers with N-alkyl substituents, and combinations thereof.

In certain embodiments, the ionic liquid has an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, or a combination thereof.

In certain preferred embodiments, the polymer electrolyte shell further comprises a flame retardant selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof. These liquid solvents, if polymerizable, may also serve as a first liquid solvent.

In certain embodiments, the first liquid solvent comprises a polymerizable and/or crosslinkable liquid solvent selected from the group consisting of fluorinated ethers, fluorinated esters, sulfones, sulfides, nitriles, sulfates, siloxanes, silanes, combinations thereof, and combinations with phosphates, phosphonates, phosphinates, phosphines, phosphine phosphonic acids, phosphorous acid, phosphites, phosphoric acids, phosphazene compounds, derivatives thereof, and combinations thereof. These materials are flame-resistant.

In some preferred embodiments, the first liquid solvent is selected from a phosphate, phosphonate, phosphinate, phosphine, or phosphine oxide having the structure of:

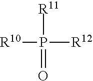

wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V (preferably no less than 4.5 V).

In some embodiments, the first liquid solvent comprises a phosphoranimine having the structure of:

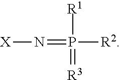

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group. The R¹, R², and R³ may be each independently selected from the group consisting of an alkoxy group, and an aryloxy group.

Preferably, the lithium salt occupies 0.1%-50% by weight and the crosslinking agent and/or initiator occupies 0.1-50% by weight of the reactive additive.

The first liquid solvents may include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃−).

Two examples of fluorinated vinyl carbonates are given below:

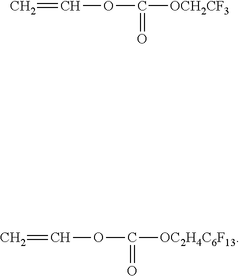

These liquid solvents can be cured in the presence of an initiator (e.g., 2-Hydroxy-2-methyl-1-phenyl-propan-1-one, Ciba DAROCUR-1173, which can be activated by UV or electron beam) if so desired:

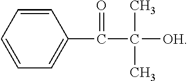

In some embodiments, the fluorinated carbonate is selected from vinyl- or double bond-containing variants of fluoroethylene carbonate (FEC), DFDMEC, FNPEC, hydrofluoro ether (HFE), trifluoro propylene carbonate (FPC), methyl nonafluorobutyl ether (MFE), or a combination thereof, wherein the chemical formulae for FEC, DFDMEC, and FNPEC, respectively are shown below:

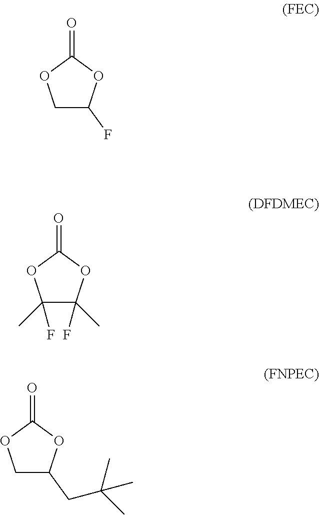

Desirable sulfones as a first liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and para-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. In certain embodiments, the sulfone as a first or the second liquid solvent is selected from TrMS, MTrMS, TMS, or vinyl or double bond-containing variants of TrMS, MTrMS, TMS, EMS, MMES, EMES, EMEES, or a combination thereof; their chemical formulae being given below:

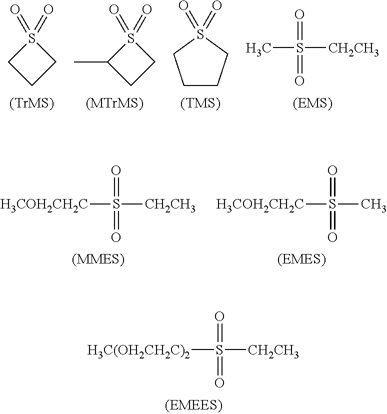

The cyclic structure, such as TrMS, MTrMS, and TMS, can be polymerized via ring-opening polymerization with the assistance of an ionic type initiator.

The first liquid solvent may be a nitrile preferably selected from dinitriles, such as AND, GLN, and SEN, which have the following chemical formulae:

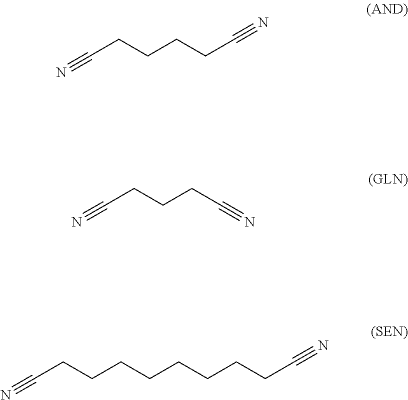 [SMILES: N#CCCCCC#N ; N#CCCCC#N ; N#CCCCCCCCCC#N]

In some embodiments, the phosphate, phosphonate, phosphazene, phosphite, or sulfate, as a first liquid solvent or in the second liquid solvent, is selected from tris(trimethylsilyl) phosphite (TTSPi), alkyl phosphate, triallyl phosphate (TAP), ethylene sulfate (DTD), a combination thereof. The phosphate, alkyl phosphonate, or phosphazene may be selected from the following:

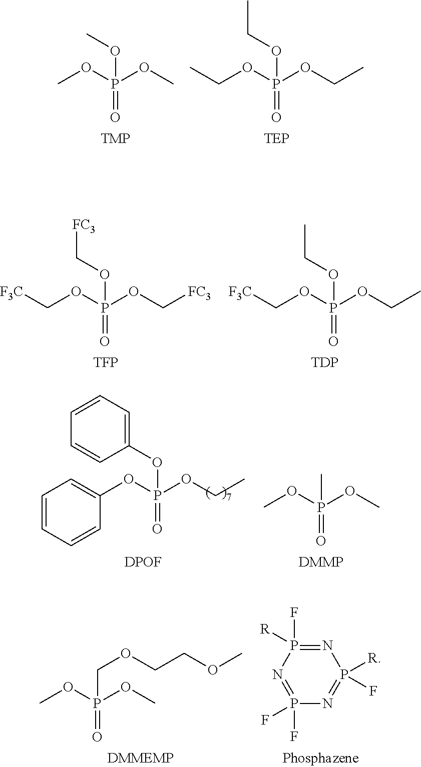

The phosphate, alkyl phosphonate, phosphonic acid, and phosphazene are flame-resistant. Good examples include diethyl vinylphosphonate, dimethyl vinylphosphonate, vinylphosphonic acid, diethyl allyl phosphate, and diethyl allylphosphonate:

The siloxane or silane in the polymerizable liquid solvent may he selected from alkylsiloxane (Si—O), alkyylsilane (Si—C), liquid oligomeric silaxane (—Si—O−Si—), or a combination thereof.

The reactive additive may further comprise an amide group selected from N,N-dimethylacetamide, N,N-diethylacetamide, N,N-dimethylformamide, N,N-diethylformamide, or a combination thereof.

In the disclosed polymer electrolyte shell, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol) diacrylate, poly(ethyleneglyeol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

The crosslinking agent preferably comprises a compound having at least one reactive group selected from a hydroxyl group, an amino group, an imino group, an amide group, an amine group, an acrylic group, or a mercapto group in the molecule. In some desired embodiments, the crosslinking agent may be selected from a chemical species represented by Chemical formula 1 below:

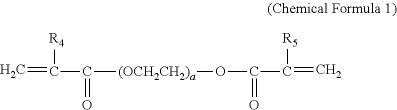

where R₄ and R₅ are each independently hydrogen or methyl group, and n is an integer from 3 to 30, wherein R′ is C₁˜C₅ alkyl group.

In some embodiments, the crosslinking agent may be selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

The polymer electrolyte shell may be in a form of a mixture, copolymer, semi-interpenetrating network, or simultaneous interpenetrating network with a second polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof. This second polymer may be pre-mixed into the polymerizable liquid solvent. Alternatively, this second polymer may be dissolved in the liquid solvent where appropriate or possible to form a solution prior to being combined with the ISE particles.

The present disclosure also provides a rechargeable lithium cell that comprises an anode, a cathode, and a separator disposed between the anode and the cathode. Preferably, the separator comprises a membrane produced from multiple hybrid solid electrolyte particulates that are consolidated together (e.g., via compression molding, extrusion, etc.).

The present disclosure further provides a rechargeable lithium battery, including a lithium metal secondary cell, a lithium-ion cell, a lithium-sulfur cell, a lithium-ion sulfur cell, a lithium-selenium cell, or a lithium-air cell. This battery features a non-flammable, safe, and high-performing electrolyte as herein disclosed.

The hybrid solid electrolyte particulates may be mixed with an electrode active material (e.g., cathode active material particles, such as NCM, NCA and lithium iron phosphate) and a conducting additive (e.g., carbon black, carbon nanotubes, expanded graphite flakes, or graphene sheets) in a liquid medium to form a slurry or paste. The slurry or paste is then made (e.g., using casting or coating) into a desired electrode shape (e.g., cathode electrode), possibly supported on a surface of a current collector (e.g., an Al foil as a cathode current collector). An anode of a lithium-ion cell may be made in a similar manner using an anode active material (e.g., particles of graphite, Si, SiO, etc.). The anode electrode, a cathode electrode, and a separator are then combined to form a battery cell.

Still another preferred embodiment of the present invention is a rechargeable lithium-sulfur cell or lithium-ion sulfur cell containing a sulfur cathode having sulfur or lithium polysulfide as a cathode active material.

For a lithium metal cell (where lithium metal is the primary active anode material), the anode current collector may comprise a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOₓ, prelithiated SiOₓ, prelithiated iron oxide, prelithiated V₂O₅, prelithiated V₃O₈, prelithiated Co₃O₄, prelithiated Ni₃O₄, or a combination thereof, wherein x=1 to 2.

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The present disclosure also provides a process for producing a plurality of the hybrid solid electrolyte particulates as discussed or defined above, the process comprising: (A) dispersing a plurality of primary particles of an inorganic solid electrolyte, having a diameter or thickness from 1 nm to 20 μm, in a reactive liquid mixture of (i) a monomer, oligomer, or cross-linkable polymer and (ii) an initiator and/or a cross-linking agent to form a reactive slurry; (B) forming the reactive slurry into micro-droplets; and (C) polymerizing and/or curing the monomer, the oligomer or the cross-linkable polymer in said micro-droplets to form the hybrid solid electrolyte particulates.

There is no particular restriction on the micro-droplet forming procedure. Preferably, step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof. The micro-droplets contain water or a liquid solvent and the process further comprises a step of removing the water or solvent.

The process may further comprise a step of combining the hybrid solid electrolyte particulates, particles of an anode active material, and a conductive additive into an anode electrode; or a step of combining said hybrid solid electrolyte particulates, particles of a cathode active material, and a conductive additive into a cathode electrode.

The process may further comprise a step of combining and consolidating the hybrid solid electrolyte particulates to form a solid electrolyte separator.

The disclosure also provides a process for producing a plurality of the hybrid solid electrolyte particulates as defined earlier, the process comprising: (a) dispersing a plurality of primary particles of an inorganic solid electrolyte, having a diameter or thickness from 1 nm to 20 μm, in a liquid solution, comprising a polymer dispersed in a liquid solvent, to form a slurry; (b) forming the slurry into micro-droplets; and (c) removing the liquid solvent in said micro-droplets to form the hybrid solid electrolyte particulates. The micro-droplet forming procedure may be selected from pan-coating, air-suspension coating, centrifugal extrusion, vibration-nozzle encapsulation, spray-drying, extrusion and palletization, kneadering, or a combination thereof.

The process may further comprise a step of combining and consolidating multiple hybrid solid electrolyte particulates to form a solid electrolyte separator (e.g., via compressing molding).

Regardless how the hybrid solid electrolyte particulate are made, the process may further comprise a step of combining and consolidating (i) the hybrid solid electrolyte particulates having a 1^{st} solid electrolyte polymer encapsulating inorganic solid electrolyte particles and (ii) anode or cathode active material particles encapsulated by a 2^{nd} solid electrolyte polymer, along with an optional conductive additive, to form an anode or cathode electrode, wherein the 1ₛₜ solid electrolyte polymer and the 2^{nd} solid electrolyte polymer are identical or different in chemical composition or structure.

These and other advantages and features of the present invention will become more transparent with the description of the following best mode practice and illustrative examples.

### BRIEF DESCRIPTION OF THE DRAWINGS

FIG. 1(A) Schematic of hybrid solid electrolyte particulates according to certain embodiments of the present disclosure.

FIG. 1(B) A process flow chart to illustrate a process for producing a plurality of hybrid solid electrolyte particulates according to some embodiments of the present disclosure.

FIG. 1(C) Another process flow chart to illustrate a process for producing a plurality of hybrid solid electrolyte particulates according to some embodiments of the present disclosure.

FIG. 1(D) A chart to illustrate a process for producing an electrode (anode or cathode) by mixing and consolidating a plurality of hybrid solid electrolyte particulates (containing a 1^{st} solid polymer electrolyte encapsulating ISE particles) and a plurality of particulates each comprising one or more than one active material particles encapsulated by a 2^{nd} solid electrolyte polymer, according to some embodiments of the present disclosure.

FIG. 2(A) Structure of an anode-less lithium metal cell (as manufactured or in a discharged state) according to some embodiments of the present disclosure.

FIG. 2(B) Structure of an anode-less lithium metal cell (in a charged state) according to some embodiments of the present disclosure.

### DETAILED DESCRIPTION

The present disclosure provides hybrid solid electrolyte particulates for use as a solid electrolyte for a safe and high-performing lithium battery, which can be any of various types of lithium-ion cells or lithium metal cells. A high degree of safety is imparted to this battery by a novel and unique electrolyte that is highly flame-resistant and would not initiate a fire or sustain a fire and, hence, would not pose explosion danger. This disclosure has solved the very most critical issue that has plagued the lithium-metal and lithium-ion industries for more than two decades.

As indicated earlier in the Background section, a strong need exists for a safe, non-flammable, yet process-friendly solid-state electrolyte system for a rechargeable lithium cell that is compatible with existing battery production facilities. It is well-known in the art that the conventional solid-state electrolyte batteries typically cannot be produced using existing lithium-ion battery production equipment or processes.

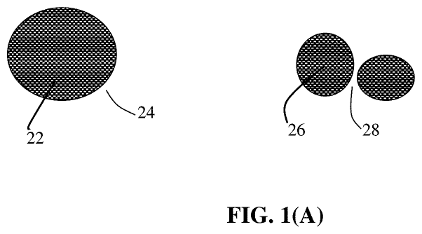

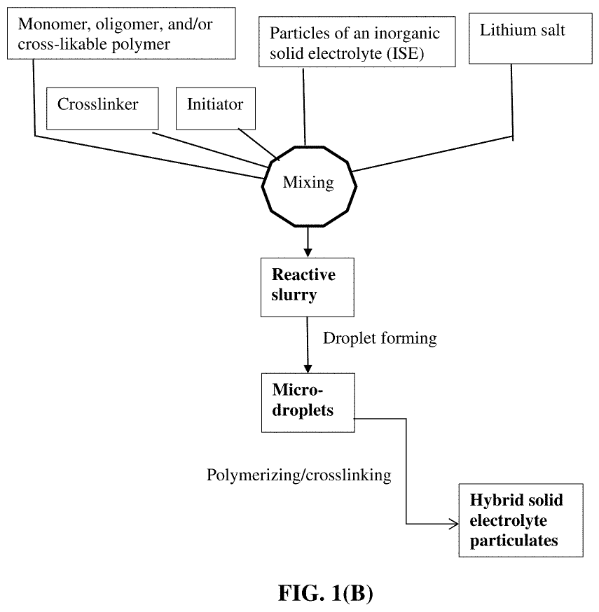

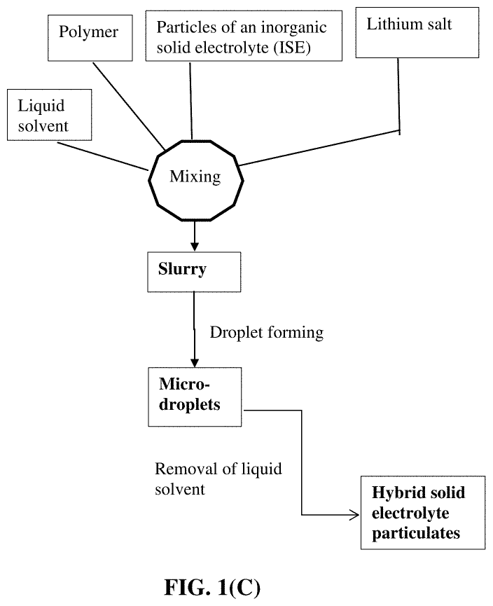

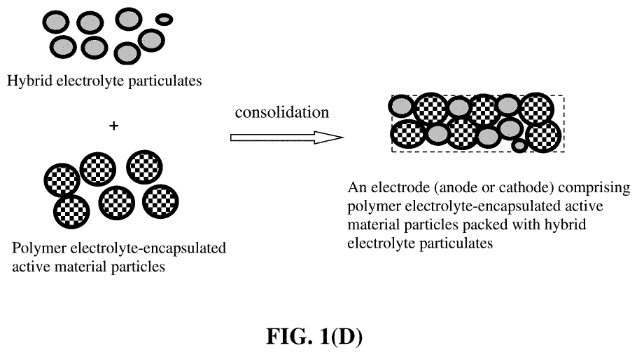

As illustrated in FIG. 1(A), the disclosed hybrid solid electrolyte particulate comprises one particle (e.g., 22) or a plurality of particles (e.g., 26) of an inorganic solid electrolyte (ISE) encapsulated by a shell of polymer electrolyte (e.g., 24, 28). This particulate or secondary particle has two main features: (i) the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10⁻⁶ S/cm and (ii) the polymer electrolyte-to inorganic solid electrolyte ratio is from 1/100 to 100/1 or the polymer electrolyte shell has a thickness from 1 nm to 10 μm. The encapsulating polymer shell preferably has a thickness from 2 nm to 2 μm, more preferably less than 1 μm, and most preferably less than 500 nm. In certain embodiments, the inorganic solid electrolyte material particles are preferably from 5 nm to 20 μm in diameter, more preferably from 20 nm to 10 μm, and most preferably smaller than 5 μm).

Also provided is a lithium-ion or lithium metal cell containing multiple hybrid solid electrolyte particulates in the anode, cathode and/or the separator.

Preferably, the hybrid electrolyte particle has a lithium-ion conductivity from 10⁻⁵ S/cm to 5×10⁻² S/cm. Preferably, the polymer electrolyte alone (without the ISE) has a lithium-ion conductivity from 10⁻⁸ S/cm to 5×10⁻² S/cm, more typically from 10⁻⁶ S/cm to 10⁻² S/cm, more preferably greater than 10⁻⁵ S/cm, furthermore preferably greater than 10⁴ S/cm, and most preferably greater than 10⁻³ S/cm.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The polymer electrolyte in the encapsulating shell may comprise a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polysilane, polyalkyl siloxane (e.g., polydimethylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a chemical derivative thereof, a copolymer thereof, a sulfonated derivative thereof, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃La_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula, with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂. (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good t conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These inorganic solid electrolyte (ISE) particles encapsulated by an electrolyte polymer shell can help enhance the lithium ion conductivity of certain polymers that have a lower ion conductivity. Preferably and typically, the polymer electrolyte has a lithium ion conductivity no less than 10⁻⁵ S/cm, more preferably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the otherwise purely ISEs processable using the current lithium-ion cell production processes.

In certain embodiments, the first liquid solvent (polymerizable) is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, phosphates, phosphonates, phosphinates, phosphines, phosphine oxides, phosphonic acids, phosphorous acid, phosphites, phosphoric acids, phosphazene compounds, ionic liquids, derivatives thereof, and combinations thereof. The optional second liquid solvent may comprise an ionic liquid.

The ionic liquid is typically composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used as a co-solvent (not as a salt) to work with the first organic solvent of the present disclosure. A well-known ionic liquid is formed by the combination of a 1-ethyl-3-methyl-imidazolium (EMI) cation and an N,N-bis(trifluoromethane)sulphonamide (TFSI) anion. This combination gives a fluid with an ionic conductivity comparable to many organic electrolyte solutions, a low decomposition propensity and low vapor pressure up to ˜300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application. Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃^{-, CH}₂CHBF₃⁻, CF₃BF₃⁻, C₂F₅BF₃⁻, n-C₃F₇BF₃ ⁻, n-C₄F₉BF₃ ⁻, PF₆ ⁻, CF₃CO₂ ⁻, CF₃SO₃ ⁻, N(SO₂CF₃)₂ ⁻, N(COCF₃)(SO₂CF₃)⁻, N(SO₂F)₂ ⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

In the conventional lithium-ion battery or lithium metal battery industry, the organic liquid solvents listed above are commonly used as a solvent to dissolve a lithium salt therein and the resulting solutions are used as a liquid electrolyte. These liquid solvents are capable of dissolving a high amount of a lithium salt; however, many of them are highly volatile, having a low flash point and being highly flammable. Further, these liquid solvents are generally not known to be polymerizable.

It is uniquely advantageous to be able to fully polymerize the liquid solvent once the liquid electrolyte (having a lithium salt dissolved in the first liquid solvent that is initially in an oligomer, partially polymerized, or partially crosslinked state) is used to form a shell that embraces and encapsulating single or multiple inorganic solid electrolyte (ISE) particles. The hybrid solid electrolyte particulates (secondary particles) can then be utilized in the anode, the cathode, and/or the separator. Multiple hybrid solid electrolyte particulates may be formed (e.g., melt fusion followed by solidification) into an ion-conducting membrane as a separator, preferably having a thickness from 10 nm to less than 100 μm. Multiple hybrid solid electrolyte particulates may also be mixed with a desired amount of an anode active material (e.g., graphite, Si, SiO particles) to form an anode (negative electrode) using a conventional electrode fabrication procedure (e.g., slurry coating process). Similarly, multiple hybrid solid electrolyte particulates may also be mixed with a desired amount of a cathode active material (e.g., lithium iron phosphate and lithium metal oxide particles) to form a cathode (positive electrode) using a conventional electrode fabrication procedure (e.g., slurry coating process). This strategy enables us to achieve several desirable attributes of the resultant hybrid electrolyte, electrodes, separator, and cell, as discussed in the Summary section.

In certain preferred embodiments, the first liquid solvent comprises a flame-resisting or flame-retardant liquid selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In certain embodiments, the first liquid solvent is selected from the group consisting of fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some embodiments, the first liquid solvent is selected from a phosphate, phosphonate, phosphinate, phosphine, or phosphine oxide having the structure of:

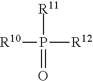

wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

In some embodiments, the first liquid solvent comprises a phosphoranimine having the structure of:

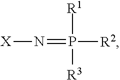

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group. The R¹, R², and R³ may be each independently selected. from the group consisting of an alkoxy group, and an aryloxy group.

The polymer electrolyte typically has a lithium-ion conductivity typically from 10⁻⁸ S/cm to 10⁻² S/cm at room temperature. The cathode may contain a cathode active material (along with an optional conductive additive and an optional resin binder) and an optional cathode current collector (such as Al foil) supporting the cathode active material. The anode may have an anode current collector, with or without an anode active material in the beginning when the cell is made. It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.

It may be noted that these first liquid solvents, upon polymerization, become essentially non-flammable. These liquid solvents were typically known to be useful for dissolving a lithium salt and not known for their polymerizability or their potential as an electrolyte polymer. In some preferred embodiments, the battery cell contains substantially no volatile liquid solvent therein after polymerization. However, it is essential to initially include a liquid solvent in the cell, enabling the lithium salt to get dissociated into lithium ions and anions and allow particles of ISE particles to get dispersed therein to form a reactive slurry for the purpose of forming secondary particles.

Desirable polymerizable liquid solvents can include fluorinated monomers having unsaturation (double bonds or triple bonds) in the backbone or cyclic structure (e.g., fluorinated vinyl carbonates, fluorinated vinyl monomers, fluorinated esters, fluorinated vinyl esters, and fluorinated vinyl ethers). These chemical species may also be used as a second liquid solvent in the presently disclosed electrolyte. Fluorinated vinyl esters include R_{f}CO₂CH═CH₂ and Propenyl Ketones, R_{f}COCH═CHCH₃, where R_{f} is F or any F-containing functional group (e.g., CF₂ — and CF₂CF₃—).

Two examples of fluorinated vinyl carbonates are given below:

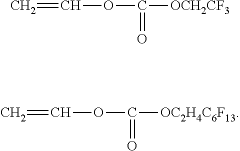

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

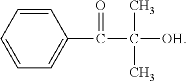

In some embodiments, the fluorinated carbonate is selected from vinyl- or double bond-containing variants of fluoroethylene carbonate (FEC), DFDMEC, FNPEC, hydrofluoro ether (HFE), trifluoro propylene carbonate (FPC), or methyl nonafluorobutyl ether (MFE), wherein the chemical formulae for FEC, DFDMEC, and FNPEC, respectively are shown below:

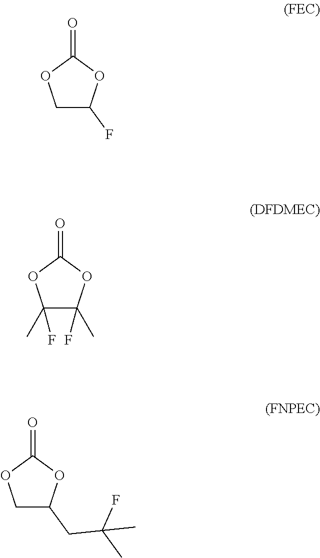

Desirable sulfones as a polymerizable first liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

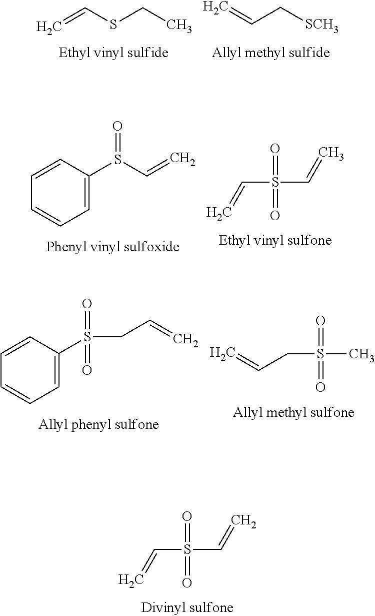

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

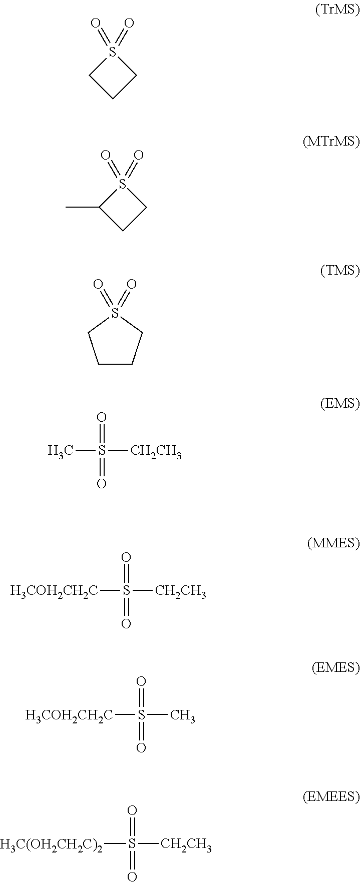

The cyclic structure, such as TrMS, MTrMS, and TMS, can be polymerized via ring-opening polymerization with the assistance of an ionic type initiator.

The nitrile may be selected from AND, GLN, SEN, or a combination thereof and their chemical formulae are given below:

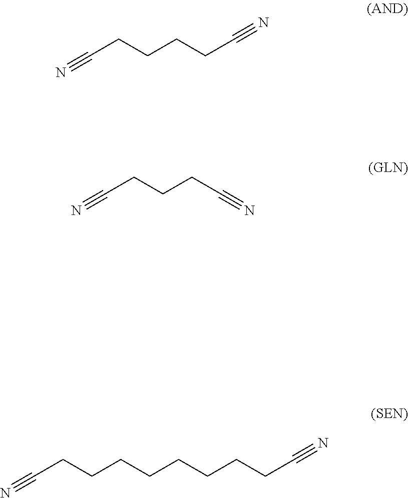 [SMILES: N#CCCCCC#N ; N#CCCCC#N ; N#CCCCCCCCCC#N]

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

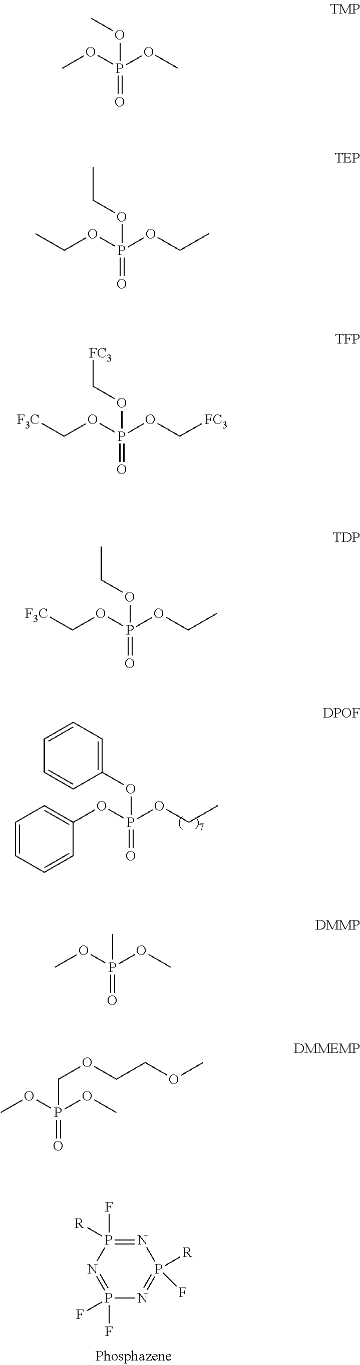

wherein R═H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). These liquid solvents may serve as a first or a second liquid solvent in the electrolyte composition. The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl ally 1phosphonate:

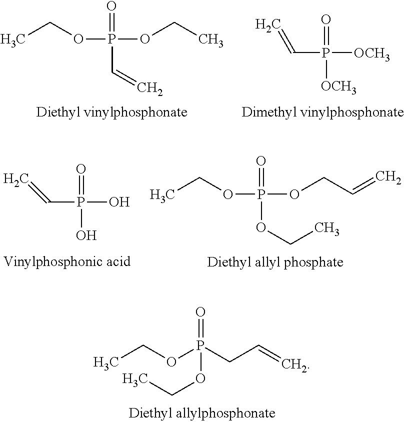

Examples of initiator compounds that can be used in the polymerization of vinylphosphonic acid are peroxides such as benzoyl peroxide, toluy peroxide, di-tert.butyl peroxide, chloro benzoyl peroxide, or hydroperoxides such as methylethyl ketone peroxide, tert.butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The silaxane or silane may be selected from alkylsiloxane (Si—O), alkyylsilane (Si—C), liquid oligomeric silaxane (—Si—O—Si—), or a combination thereof.

The reactive additive may further comprise an amide group selected from N,N-dimethylacetamide N,N-diethylacetamide, N,N-dimethylformamide N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol) diacrylate, poly(ethyleneglycol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate diisopropyl peroxydicarbonate, or a combination thereof.

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 2:

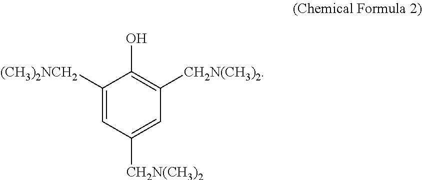

In the rechargeable lithium battery, the reactive additive may further comprise a chemical species represented by Chemical Formula 3 or a derivative thereof and the crosslinking agent comprises a chemical species represented by Chemical Formula 4 or a derivative thereof:

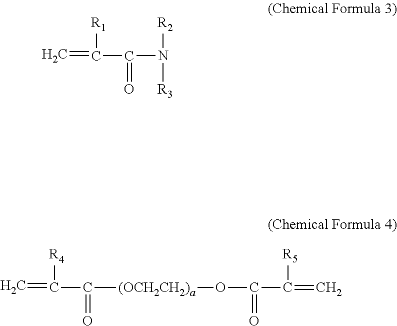

where R₁ is hydrogen or methyl group, and R₂ and R₃ are each independently one selected from the group consisting of hydrogen, methyl, ethyl, propyl, dialkylaminopropyl (—C₃ H₆ N(R¹)₂) and hydroxyethyl (CH₂ CH₂ OH) groups, and R₄ and R₅ are each independently hydrogen or methyl group, and n is an integer from 3 to 30, wherein R′ is C₁˜C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent is preferably selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

The polymer in the electrolyte may be in a form of a polymer blend, copolymer, semi-interpenetrating network, or simultaneous interpenetrating network. The polymer in the encapsulating shell may be selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

The inorganic solid electrolyte particles encapsulated by an electrolyte polymer can help enhance the lithium-ion conductivity of the resulting hybrid solid electrolyte particulates if the encapsulating polymer has an intrinsically low ion conductivity. Preferably and typically, the polymer has a lithium-ion conductivity no less than 10⁻⁵ S/cm, more preferably no less than 10⁻⁴ S/cm, and further preferably no less than 10⁻³ S/cm.

The disclosed lithium battery can be a lithium-ion battery or a lithium metal battery, the latter having lithium metal as the primary anode active material. The lithium metal battery can have lithium metal implemented at the anode when the cell is made. Alternatively, the lithium may be stored in the cathode active material and the anode side is lithium metal-free initially. This is called an anode-less lithium metal battery.

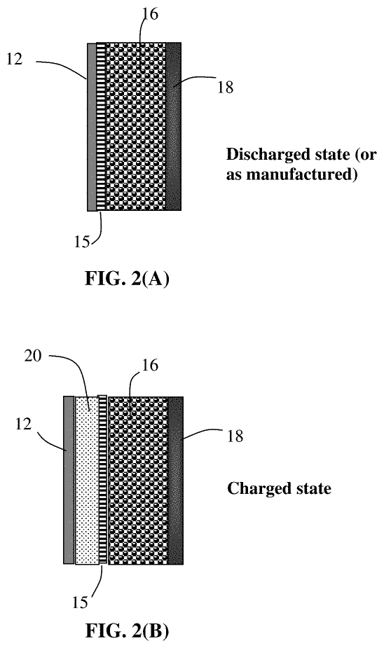

As illustrated in FIG. 2(A), the anode-less lithium cell is in an as-manufactured or fully discharged state according to certain embodiments of the present disclosure. The cell comprises an anode current collector 12 (e.g., Cu foil), a separator, a cathode layer 16 comprising a cathode active material, an optional conductive additive (not shown), an optional resin binder (not shown), and a plurality of the presently disclosed hybrid solid electrolyte particulates (dispersed in the entire cathode layer and in contact with the cathode active material), and a cathode current collector 18 that supports the cathode layer 16. There is no lithium metal in the anode side when the cell is manufactured. The separator can be a polymeric membrane, solid-state electrolyte, or preferably a separator made from consolidation of multiple hybrid solid electrolyte particulates herein provided.

In a charged state, as illustrated in FIG. 2(B), the cell comprises an anode current collector 12, lithium metal 20 plated on a surface (or two surfaces) of the anode current collector 12 (e.g., Cu foil), a separator 15, a cathode layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector.

One unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode only contains a current collector or a protected current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities should be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may comprise graphene balls and/or graphene foam. Preferably, the graphene layer has a thickness from 1 nm to 50 μm and/or has a specific surface area from 5 to 1000 m²/g (more preferably from 10 to 500 m²/g).

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In addition to the non-flammability and high lithium ion transference numbers, there are several additional benefits associated with using the presently disclosed solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂, lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there should be a lithium source implemented in the cathode side to begin with.

The processes that can be used to produce the hybrid solid electrolyte particulates are herein further discussed. For convenience, we will divide polymers into two types. The first type contains those polymers that have been fully polymerized and not cross-linkable (e.g., linear-chain or branched polymers that can be dissolved in a liquid solvent). The second type contains those materials that remain in the monomer state (e.g., monomer+initiator+optional curing agent), oligomer state (live short chains that are capable of growing and/or cross-linking), or cross-linkable polymer (e.g., having at least 3 functional groups for reacting with other chains or curing agents).

As illustrated in FIG. 1(C), for those first-type polymers that are soluble in a liquid solvent one can begin by dissolving a polymer (optionally but preferably, along with a desired amount of a lithium salt) to form a polymer/solvent liquid solution. A desired amount of fine particles (e.g., 5 nm to 10 μm in diameter) of an inorganic solid electrolyte (ISE) are then dispersed into the liquid solution to form a slurry. The slurry may then be formed into hybrid particulates (polymer electrolyte-encapsulated ISE secondary particles) using any known particle-forming procedure combined with solvent removal (e.g., spray-drying).

In some other examples based on the second-type polymers (illustrated in FIG. 1(B)), the polymer electrolyte as the encapsulating shell in the hybrid solid electrolyte particulate comprises a polymer that is a polymerization or crosslinking product of a reactive additive comprising (i) a first liquid solvent that is polymerizable and/or cross-linkable, (ii) an initiator and/or curing agent, and (iii) a lithium salt (optional but desirable), wherein the first liquid solvent occupies from 1% to 99% by weight based on the total weight of the reactive additive.

In these examples, a desired amount of fine particles of an inorganic solid electrolyte may be dispersed in the reactive additive to form a reactive slurry. The slurry may then be formed into secondary particles having ISE particles being embraced with a thin layer of reactive additive. This is followed by polymerization and/or crosslinking to form the hybrid solid electrolyte particulates, wherein each particulate comprises one or more than one primary particles of an ISE being encapsulated by a substantially solid polymer electrolyte. Preferably, at least 30% by weight of the polymerizable first liquid solvent is polymerized; more preferably >50%, further preferably >70%, and most preferably >99% is polymerized.

Shown in FIG. 1(D) is a schematic to illustrate a process for producing an electrode (anode or cathode) by mixing and consolidating (i) a plurality of hybrid solid electrolyte particulates each containing a 1^{st} solid polymer electrolyte encapsulating ISE particles; (ii) a plurality of particulates each comprising one or more than one active (anode or cathode) material particles encapsulated by a 2^{nd} solid electrolyte polymer; and optionally (iii) conducting additive. The 1^{st} electrolyte polymer may be identical to or different than the 2^{nd} electrolyte polymer. These hybrid solid electrolyte particulates and the active material particulates are preferably packed together in such a manner that the polymers in the shell form a contiguous phase capable of transporting lithium ions. Further preferably, the 1^{st} and the 2^{nd} electrolyte polymers are fused or consolidated together.

Several micro-encapsulation processes require the polymer to be dissolvable in a solvent or its precursor (or monomer or oligomer) initially contains a liquid state (flowable). Fortunately, all the polymers or their precursors used herein are soluble in some common solvents or the monomer or other polymerizing/curing ingredients are in a liquid state to begin with.

There are three broad categories of micro-encapsulation methods that can be implemented to produce electrolyte polymer-embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization. In all of these methods, polymerization and/or crosslinking may be allowed to proceed during and/or after the micro-droplet formation procedure.

Pan-coating method: The pan coating process involves tumbling the primary particles of an inorganic solid electrolyte (ISE) in a pan or a similar device while the matrix material (e.g. monomer/oligomer liquid or uncured polymer/solvent solution; possibly containing a lithium salt dispersed or dissolved therein) is applied slowly until a desired amount of particulates is attained.

Air-suspension coating method: In the air suspension coating process, the solid primary particles of an ISE are dispersed into the supporting air stream in an encapsulating chamber. A controlled stream of a reactive precursor solution (e.g., polymer or its monomer or oligomer dissolved in a solvent; or its monomer or oligomer alone in a liquid state) is concurrently introduced into this chamber, allowing the solution to hit and coat/embed the suspended particles. These suspended particles are encapsulated by or embedded in the reactive precursor (monomer, oligomer, etc. which is polymerized/cured concurrently or subsequently) while the volatile solvent is removed, leaving behind a hybrid particulate. This process may be repeated several times until the required parameters, such as full-encapsulation, are achieved. The air stream which supports the ISE particles also helps to dry them, and the rate of drying is directly proportional to the temperature of the air stream, which can be adjusted for an optimized polymer amount.

In a preferred mode, the ISE particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating polymer or precursor amount is achieved.

Centrifugal extrusion: Primary anode particles may be embedded in a polymer network or precursor material using a rotating extrusion head containing concentric nozzles. In this process, a stream of core fluid (slurry containing anode particles dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: polymer-encapsulation of ISE particles can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the ISE active material particles and the polymer or precursor.

Spray-drying: Spray drying may be used to encapsulate ISE particles when the particles are suspended in a melt or polymer/precursor solution to form a suspension. In spray drying, the liquid feed (solution or suspension) is atomized to form droplets which, upon contacts with hot gas, allow solvent to get vaporized and thin shell of a polymer or precursor to fully embrace the particles.

Coacervation-phase separation: This process includes three steps carried out under continuous agitation:
(a) Formation of three immiscible chemical phases: liquid manufacturing vehicle phase, core material phase and encapsulation material phase. The ISE primary particles are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation material: ISE particles being dispersed in the encapsulating polymer solution, encapsulating polymer/precursor coated around ISE particles, and deposition of liquid polymer embracing around ISE particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A suspension of the ISE particles and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical group to form a polymer shell material.

In-situ polymerization: In some micro-encapsulation processes, the ISE particles are fully embedded in a monomer or oligomer first. Then, direct polymerization of the monomer or oligomer is carried out with the presence of these material particles dispersed therein.

Matrix polymerization: This method involves dispersing and embedding ISE primary particles in a polymeric matrix during formation of the particles. This can be accomplished via spray-drying, in which the particles are formed by evaporation of the solvent from the matrix material. Another possible route is the notion that the solidification of the matrix is caused by a chemical change.

The following examples are presented primarily for the purpose of illustrating the best mode practice of the present disclosure, not to be construed as limiting the scope of the present invention.

It may be noted that the more desirable and typical lithium ion conductivity of the polymer herein studied is from 10⁻⁶ S/cm to 5×10⁻² S/cm and that of the inorganic solid electrolyte (ISE) is from 10⁻⁶ S/cm to 2×10⁻² S/cm. The ISE-to-polymer electrolyte volume ratio can be from 1/100 to 100/1, but typically from 5/95 to 95/5, more typically from 10/90 to 90/10, further more typically from 20/80 to 80/20, and most typically from 30/70 to 70/30. The goal is to achieve a lithium ion conductivity of the resulting hybrid electrolyte particulate from 10⁻⁵ S/cm to 5×10⁻² S/cm, preferably greater than 10⁻⁴ S/cm, and more preferably greater than 10⁻³ S/cm.

### EXAMPLE 1

### Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### EXAMPLE 2

### Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### EXAMPLE 3

### Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### EXAMPLE 4

### Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Z_{1.95}M_{0.05}O_{3.95}, SiO₂, and NH₄H₂PO₄ at 1260° C.

### EXAMPLE 5

### Lithium Metal Cell Containing a Polymerized VC or FEC as the First Liquid Solvent

In one example, vinylene carbonate (VC) or fluoroethylene carbonate (FEC) as a first liquid solvent, and poly(ethylene glycol) diacrylate (PEGDA, as a crosslinking agent) were stirred under the protection of argon gas until a homogeneous solution was obtained. Subsequently, lithium hexafluoro phosphate, as a lithium salt, was added and dissolved in the above solution to obtain a reactive mixture solution, wherein the weight fractions of VC or FEC. polyethylene glycol diacrylate, and lithium hexafluoro phosphate were 85 wt %, 10 wt %, and 5 wt %, respectively. A desired amount of Li₇La₃Zr₂O₁₂ particles was dispersed into this reactive additive to form a slurry. The slurry was then partially polymerized by exposing the solution to electron beam at room temperature until a total dosage of 20 Gy was reached, imparting some viscosity to the slurry. The slurry was spray-dried to obtain micro-droplets, which were further exposed to electron beam for another dosage of 20 Gy, allowing for polymerization of the polymerizable first liquid solvent to be completed to obtain the hybrid particulates.

A lithium metal cell was made, comprising a lithium metal foil as the anode active material, a cathode (comprising 75% by weight of LiCoO₂ as the cathode active material, 15% of hybrid particulates, 5% PVDF binder, and 5% combined graphene/CNT as a conductive additive), and a solid-state electrolyte-based separator composed of particles of Li₇La₃Zr₇O₁₂ embedded in a poly(vinylidene fluoride)-hexafluoropropylene (PVDF-HFP) matrix (inorganic solid electrolyte/PVDF-HFP ratio=4/6).

### EXAMPLE 6

### 1,3-dioxolane (DOL) as the Polymerizable First Liquid Solvent

The polymerizable liquid electrolyte composition comprises anhydrous DOL (99.8%, containing approximately 75 ppm butylated hydroxytoluene (BHT) as inhibitor; Sigma-Aldrich). A total of 0.6 M LiTFSI (TCI America) and 0.4 M LiDFOB (Sigma-Aldrich) were added to the above solvent to prepare the electrolytes. One electrolyte was prepared by dissolving the salts in pure DOL. In several electrolytes, a ternary salt composition (0.6 M LiTFSI+0.2 M LiDFOB and 0.2 M LiBOB [Sigma-Aldrich]) was used to prepare the electrolytes using the same process. Aluminum triflate (Al(OTf)3, 99%; Alfa Aesar) with a concentration of 2 mM was also added to accelerate the polymerization reaction. Electrolyte compositions used in the study were created by diluting the homogeneous solutions of DOL-Al(OTf)3 with appropriate amounts of DOL-LITFSI to create initially liquid DOL electrolytes containing variable fractions of Al(OTf)3. All of the liquid electrolytes were separately mixed with LGPS-type solid electrolyte obtained in Example 2 to form several separate slurry samples. The polymerization of DOL typically can be completed at 25-75° C. for 1-48 hours. One could wait until a certain degree of polymerization is reached to achieve a desired reactive liquid viscosity conducive to spray-drying for the formation of micro-droplets. Subsequently, one could increase the reaction temperature to complete the polymerization.

### EXAMPLE 7

### VC or FEC as the Polymerizable Liquid Solvent

In this study, VC or FEC was used as the first liquid solvent, azodiisobutyronitrile (AIBN) as the initiator, and lithium difluoro(oxalate) borate (LiDFOB) as the lithium salt.

Solutions containing 1.5 M LiDFOB in VC and FEC, respectively, and 0.2 wt % AIBN (vs VC or FEC) were prepared. The particles of the ISE obtained in Example 3 were dispersed into the reactive electrolyte solutions to obtain slurries. The slurry samples were stored at 60° C. for 24 h and spray-dried to form micro-droplets, which were subjected to heating at 80° C. for another 2 h to obtain polymerized VC- or polymerized FEC-encapsulated ISE particles. The polymerization scheme of VC is shown below (Reaction scheme 1):

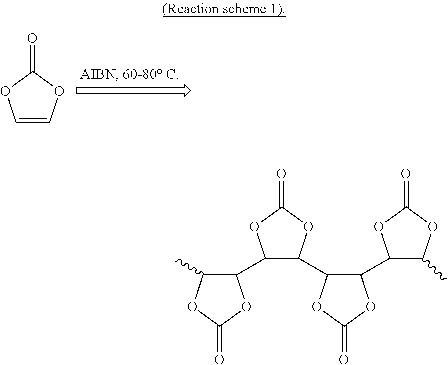

### EXAMPLE 8

### Encapsulating Polymer from Vinylphosphonic Acid (VPA) and Triethylene Glycol Dimethacrylate (TEGDA) or Acrylic Acid (AA)

Select ISE particles were encapsulated with a flame-resistant polymer. The free radical polymerization of acrylic acid (AA) with vinylphosphonic acid (VPA) can be catalyzed with benzoyl peroxide as the initiator. In a vessel provided with a reflux condenser, 150 parts vinylphosphonic acid were dissolved in 150 parts isopropanol and heated for 5 hours at 90° C. together with 0.75 parts benzoyl peroxide and 20 parts of lithium bis(oxalato)borate (LiBOB). A very viscous clear solution of polyvinylphosphonic acid was obtained. On a separate basis, a similar reactive mixture was added with a desirable amount (e.g., 10-50 parts) of AA or TEGDA as a co-monomer. The SEI particles obtained in Example 2 and 4, respectively, were then added into the solution to form a slurry, which was then dried and cured in a vacuum oven at 90° C. for 5 hours to obtain a solid mass of polymer-encapsulated ISE particles. The solid mass was subjected to mechanical shearing in a food processor to produce separated hybrid particulates.

### EXAMPLE 9

### Diethyl Vinylphosphonate and Diisopropyl Vinylphosphonate Polymers for ISE Encapsulation

Both diethyl vinylphosphonate and diisopropyl vinylphosphonate were polymerized by a peroxide initiator (di-tert-butyl peroxide), along with LiBF₄, to clear, light-yellow polymers of low molecular weight. In a typical procedure, either diethyl vinylphosphonate or diisopropyl vinylphosphonate (being a liquid at room temperature) is added with di-tert-butyl peroxide (0.5-2% by weight) and LIBF₄ (5-10% by weight) to form a reactive solution. ISE nano particles obtained in Examples 1 and 3, respectively, were separately dispersed into the reactive solution. The resulting suspension was heated to 45° C., allowing hulk polymerization to proceed for 2-12 hours. Subsequently, the suspension was spray-dried to form hybrid solid electrolyte particulates.

### EXAMPLE 10

### Vinyl Ethylene Sulfite (NES) as the Polymerizable Liquid Solvent

Under the protection of an argon gas atmosphere, vinyl ethylene sulfite (YES) and tetra(ethylene glycol) diacrylates were stirred evenly to form a solution. Bis trifluoromethyl sulfimide lithium was then dissolved in the solution to obtain a solution mixture. In this solution mixture, the weight fractions for the three ingredients were VEC (60%), tetra(ethylene glycol) diacrylates (20%), and bis trifluoromethyl sulfimide, (10%). The mixed solution was coated onto surfaces of the ISE particles prepared in Example 1 using pan-coating. The sample was exposed to electron beam at 50° C. until a dosage of 20 kGy was reached. VEC was polymerized and crosslinked to become a solid polymer-encapsulated ISE particulates.

### EXAMPLE 11

### Lithium-Ion Cell Featuring Polymerized Phenyl Vinyl Sulfide (PVS) as the Encapsulating Shell

Phenyl vinyl sulfide (first liquid solvent), CTA (chain transfer agent, shown below), AIBN (initiator, 1.0%), and 5% by weight of lithium trifluoro-metasulfonate (LiCF₃SO₃), were coated onto surfaces of ISE particles obtained in Sample 2 using pan-coating. The sample of coated particles was heated at 60° C. to obtain PPVS polymer electrolyte-coated ISE particles obtained in Example 4. These hybrid particles (25% by wt.) were then mixed with Si nano particles (70% by wt.), CNTs (1%), and carbon black particles (4%) to form an anode electrode.

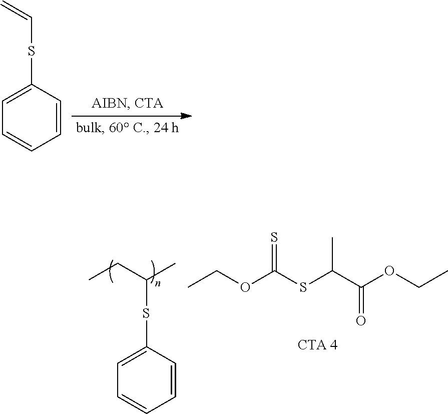

### EXAMPLE 12

### Lithium-Ion Cell Featuring Polymerized Phenyl Vinyl Sulfone-Encapsulated ISE Particulates

The lithium-ion cells prepared in this example comprise an anode of graphene-protected Si particles, a cathode of NCM-622 particles, PVSn-encapsulated ISE particles prepared in Example 2, and a porous PE/PP membrane as a separator.

Phenyl vinyl sulfone (PVS) can be polymerized with several anionic-type initiators; e.g., n-BuLi, ZnEt2, LiN(CH₂)₂, and NaNH₂. A mixture of PVS, n-BuLi (1.0% relative to PVS), and LiBF₄ (0.5 M) was thoroughly mixed and then coated onto ISE particles using pan-coating. The resulting reactive mass was maintained at 30° C. overnight to cure the polymer.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing hybrid solid-state electrolyte particulates perform very well. These cells are flame resistant and relatively safe.

### EXAMPLE 13

### Hybrid Solid State Electrolytes from ISE Particles Encapsulated by Cyclic Esters of Phosphoric Acid

As selected examples of polymers from phosphates, five-membered cyclic esters of phosphoric acid of the general formula: —CH₂CH(R)OP(O)—(OR′)O— were polymerized to solid, soluble polymers of high molecular weight by using n-C₄H₉Li, (C₅H₅)₂Mg, or (i-C₄H₉)₃Al as initiators. The resulting polymers have a repeating unit as follows:

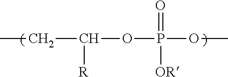

where R is H, with R′═CH₃, C₂H₅, n-C₃ H₇, i-C₃H₇; n-C₄H₉, CCl₃CH₂, or C₆H₅, or R is CH₂Cl and R′ is C₂H₅. The polymers typically have Mₙ=10⁴-10⁵.

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′═H in the following chemical formula):

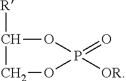

The mixture was mixed with ISE particles to form a reactive mixture and the anionic polymerization was allowed to proceed at room temperature (or lower) overnight to produce a sample containing hybrid solid electrolyte particulates. Portion of the sample was ball-milled to obtain separated hybrid electrolyte particulates for use in the anode and the cathode of a lithium cell. On a separate basis, portion of the sample was cast and formed into a layer of separator of approximately 20 μm in thickness. The room temperature lithium ion conductivities of this series of solid electrolytes are in the range of 2.5×10⁻⁵ S/cm-1.1×10⁻³ S/cm.

Both Li metal cells (containing a lithium foil as an anode material) and Li-ion cells (containing artificial graphite particles as an anode active material) were prepared. Both cells comprise NCA particles as the cathode active material.

### EXAMPLE 14

### Hybrid Solid State Electrolytes from ISE Particles Encapsulated by Poly(Vinylidene Fluoride)-Hexafluoropropylene (PVDF-HFP)

PVDF-HFP can be readily dissolved in polar solvents such as dimethylacetamide (DMAc) and acetone to form a polymer solution. The ISE particles (as prepared in Examples 1-4) were respectively dispersed into the PVDF-HFP/DMAc or PVDF-HFP/acetone solutions to prepare slurries. The slurries were then spray-dried to obtain hybrid solid electrolyte particulates.

The melting points of PVDF-HFP are typically in the range of 115-135° C. One could readily use processes such as compression molding, extrusion, and roll-pressing (e.g., involving a temperature above 135° C.) to form PVDF-HFP-encapsulated ISE particles into a separator layer.

Similarly, anode active materials particles (e.g., Si or graphite) and cathode active material particles (e.g., LFP or NCM) were respectively dispersed into the PVDF-HFP/DMAc or PVDF-HFP/acetone solutions to prepare slurries. The slurries were then spray-dried to obtain anode particulates (containing PVDF-HFP-encapsulated anode active particles) and cathode particulates (containing PVDF-HFP-encapsulated cathode active particles).

A desired proportion of anode particulates (typically 50-95% by wt., more desirably >65% and further desirably >75%), hybrid solid electrolyte particulates, and a conductive additive (e.g., 2-10% of CNTs and/or carbon black) were then combined and compacted into an anode electrode. In some samples, heat was used to further fuse and consolidate these particulates in the electrode.

A desired proportion of cathode particulates (typically 50-95% by wt., more desirably >65% and further desirably >75%), hybrid solid electrolyte particulates, and a conductive additive (e.g., 2-10% of CNTs and/or carbon black) were then combined and compacted into a cathode electrode. In some samples, heat was used to further fuse and consolidate these particulates in the electrode.

1. A hybrid solid electrolyte particulate for use in a rechargeable lithium battery cell, wherein said particulate comprises one or more than one inorganic solid electrolyte particles encapsulated by a shell of polymer electrolyte wherein (i) the hybrid solid electrolyte particulate has a lithium-ion conductivity from 10⁻⁶ S/cm to 5×10⁻² S/cm and both the inorganic solid electrolyte and the polymer electrolyte individually have a lithium-ion conductivity no less than 10⁻⁶ S/cm and (ii) the polymer electrolyte-to-inorganic solid electrolyte ratio is from 1/100 to 100/1 or the polymer electrolyte shell has a thickness from 1 nm to 10 μm.

2. The hybrid solid electrolyte particulate of claim 1, wherein the inorganic solid electrolyte material is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

3. The hybrid solid electrolyte particulate of claim 1, wherein the polymer electrolyte comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, poly(alkylsiloxane), poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(dimethyl siloxane), poly(alkyl siloxane), poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a chemical derivative thereof, a copolymer thereof, a sulfonated derivative thereof, or a combination thereof.

4. The hybrid solid electrolyte particulate of claim 1, wherein the polymer electrolyte comprises a polymer that is a polymerization or crosslinking product of a reactive additive comprising (i) a first liquid solvent that is polymerizable and/or crosslinkable, (ii) an initiator and/or curing agent, and (iii) a lithium salt; wherein the first liquid solvent occupies from 1% to 99% by weight based on the total weight of the reactive additive.

5. The hybrid solid electrolyte particulate of claim 4, wherein the first liquid solvent is selected from the group consisting of vinylene carbonate, ethylene carbonate, fluoroethylene carbonate, ethylene glycol phenyl ether acrylate) (PEGPEA), ethoxylated trimethyl propyl triacrylate (ETPTA), tetrahydrofuran (THF), vinyl sulfite, vinyl ethylene sulfite, vinyl ethylene carbonate, 1,3-propyl sultone, 1,3,5-trioxane (TXE), 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, dinitriles, acrylonitrile (AN), sulfates, siloxanes, silanes, N-methylacetamide, acrylates, ethylene glycols, phosphates, phosphonates, phosphinates, phosphines, phosphine oxides, phosphonic acids, phosphorous acid, phosphites, phosphoric acids, phosphazene compounds, derivatives thereof, and combinations thereof.

6. The hybrid solid electrolyte particulate of claim 4, wherein the first liquid solvent is selected from a phosphate, phosphonate, phosphonate, phosphine, or phosphine oxide having the structure of: 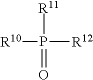
wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

7. The hybrid solid electrolyte particulate of claim 4, wherein the first liquid solvent comprises a phosphoranimine having the structure of: 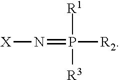
wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group.

8. The hybrid solid electrolyte particulate of claim 7, wherein R¹, R², and R³ are each independently selected from the group consisting of an alkoxy group, and an aryloxy group.

9. The rechargeable lithium cell of claim 1, wherein the lithium salt occupies 0.1%-30% by weight and the crosslinking agent and/or the initiator occupies 0.1-50% by weight of the reactive additive.

10. The hybrid solid electrolyte particulate of claim 4, wherein the first liquid solvent comprises a solvent selected from the group consisting of fluorinated vinyl carbonates, fluorinated vinyl monomers, fluorinated esters, fluorinated vinyl esters, and fluorinated vinyl ethers and combinations thereof.

11. The hybrid solid electrolyte particulate of claim 4, wherein the first liquid solvent comprises a sulfone or sulfide selected from vinyl sulfone, allyl sulfone, alkyl vinyl sulfone, aryl vinyl sulfone, vinyl sulfide, TrMS, MTrMS, TMS, EMS, MMES, EMES, EMEES, or a combination thereof:

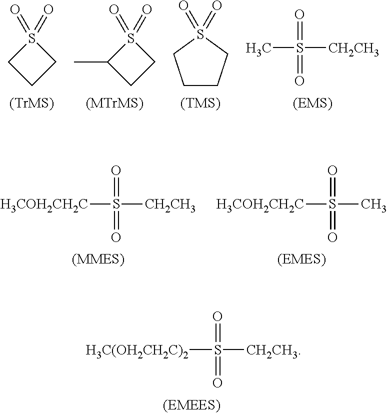

12. The hybrid solid electrolyte particulate of claim 11, wherein the vinyl sulfone or sulfide is selected from ethyl vinyl sulfide, allyl methyl sulfide, phenyl vinyl sulfide, phenyl vinyl sulfoxide, allyl phenyl sulfone, sulfone, divinyl sulfone, or a combination thereof, wherein the vinyl sulfone does not include methyl ethylene sulfone and ethyl vinyl sulfone.

13. The hybrid solid electrolyte particulate of claim 4, wherein the first liquid solvent comprises a nitrile, a dinitrile selected from ADN, GLN, or SEN, or a combination thereof:

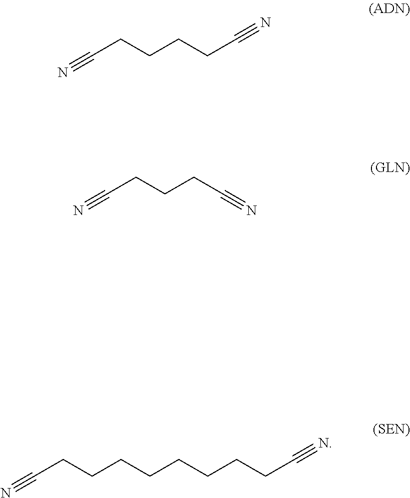 [SMILES: N#CCCCCC#N ; N#CCCCC#N ; N#CCCCCCCCCC#N]

14. The hybrid solid electrolyte particulate of claim 4, wherein the first liquid solvent comprises a phosphate selected from allyl-type, vinyl-type, styrenic-type and (meth)acrylic-type monomers bearing a phosphonate moiety.

15. The hybrid solid electrolyte particulate of claim 4, wherein the first liquid solvent comprises a phosphate, phosphonate, phosphonic acid, phosphazene, or phosphite selected from TMP, TEP, TTP, TDP, DPOF, DMMP, DMMEMP, tris(trimethylsilyl)phosphite (TTSPi), alkyl phosphate, triallyl phosphate (TAP), or a combination thereof, wherein TMP, TEP, TFP, TDP, DPOF, DMMP, DMMEMP, and phosphazene have the following chemical formulae: 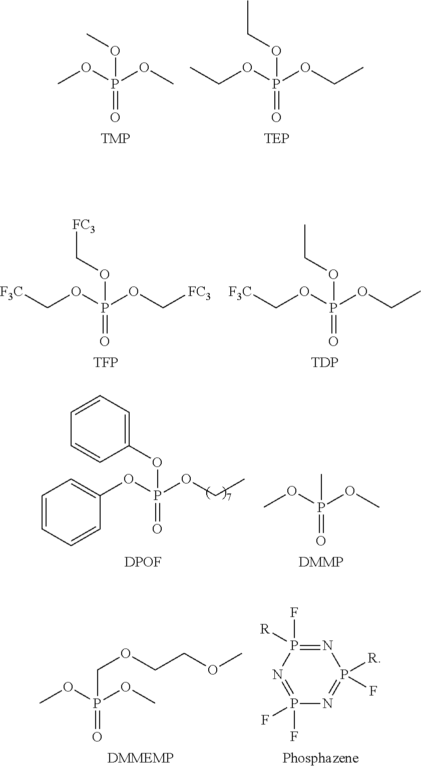
wherein R═H, NH₂, or C₁-C₆ alkyl.

16. The hybrid solid electrolyte particulate of claim 4, wherein the first liquid solvent comprises siloxane or silane selected from alkylsiloxane (Si—O), alkyylsilane (Si—C), liquid oligomeric silaxane (—Si—O—Si—), or a combination thereof.

17. The hybrid solid electrolyte particulate of claim 4, wherein the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

18. The hybrid solid electrolyte particulate of claim 4, wherein the crosslinking agent is selected from poly(diethanol) diacrylate, poly(ethyleneglycol)dimethacrylate, poly(diethanol) dimethylacrylate, poly(ethylene glycol) diacrylate, or a combination thereof.

19. The hybrid solid electrolyte particulate of claim 4, wherein said initiator is selected from an azo compound, azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

20. The hybrid solid electrolyte particulate of claim 4, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

21. The hybrid solid electrolyte particulate of claim 1, wherein said shell of polymer electrolyte further comprises a lithium salt.

22. A rechargeable lithium cell comprising an anode, a cathode, and a separator disposed between the anode and the cathode, wherein at least one of the anode, the cathode, and the separator comprises multiple hybrid solid electrolyte particulates as defined in claim 1.

23. The rechargeable lithium cell of claim 22, wherein:
the hybrid solid electrolyte particulates comprise a 1^{st} solid electrolyte polymer encapsulating inorganic solid electrolyte particles;
the anode comprises multiple anode particulates comprising anode active material particles encapsulated by a 2^{nd} solid electrolyte polymer, wherein the 1^{st} solid electrolyte polymer and the 2^{nd} solid electrolyte polymer are identical or different in chemical composition or structure; and
the hybrid solid electrolyte particulates and the anode particulates are compacted or consolidated to form the anode.

24. The rechargeable lithium cell of claim 22, wherein:
the hybrid solid electrolyte particulates comprise a 1^{st} solid electrolyte polymer encapsulating inorganic solid electrolyte particles;
the cathode comprises multiple cathode particulates each comprising cathode active material particles encapsulated by a 2^{nd} solid electrolyte polymer, wherein the 1^{st} solid electrolyte polymer and the 2^{nd} solid electrolyte polymer are identical or different in chemical composition or structure; and
the hybrid solid electrolyte particulates and the cathode particulates are compacted or consolidated to form the cathode.

25. The rechargeable lithium cell of claim 22, wherein the cathode comprises a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋₋ₚO₂, 0<p<1), or lithium nickel manganese oxide (LiNi_{q}Mn_{2-q}O₄, 0<q<2).

26. The rechargeable lithium cell of claim 22, which is a lithium-ion cell wherein the anode comprises an anode active material selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

27. The rechargeable lithium cell of claim 22, which is a lithium metal secondary cell, a lithium-ion cell, a lithium-sulfur cell, a lithium-ion sulfur cell, a lithium-selenium cell, or a lithium-air cell.

28. The rechargeable lithium cell of claim 23, further including a conductive additive that is compacted or consolidated with the hybrid solid electrolyte particulates and the anode particulates to form the anode.

29. The rechargeable lithium cell of claim 24, further including a conductive additive that is compacted or consolidated with the hybrid solid electrolyte particulates and the anode particulates to form the anode.

30. A process for producing a plurality of the hybrid solid electrolyte particulates as defined in claim 1, said process comprising:
(A) dispersing a plurality of primary particles of an inorganic solid electrolyte, having a diameter or thickness from 1 nm to 20 μm, in a reactive liquid mixture of (i) a monomer, oligomer, or cross-linkable polymer and (ii) an initiator and/or a cross-linking agent to form a reactive slurry;
(B) forming the reactive slurry into micro-droplets; and
(C) polymerizing and/or curing the monomer, the oligomer or the cross-linkable polymer in said micro-droplets to form the hybrid solid electrolyte particulates.

31. The process of claim 30, wherein said step (B) of forming micro-droplets comprises a procedure selected from pan-coating, air-suspension coating, centrifugal extrusion, vibration-nozzle encapsulation, spray-drying, kneadering, casting and drying, coacervation-phase separation, interfacial polycondensation or interfacial cross-linking, in-situ polymerization, matrix polymerization, extrusion and palletization, or a combination thereof.

32. The process of claim 30, wherein said micro-droplets contain water or a liquid solvent and the process further comprises a step of removing said water or solvent.

33. The process of claim 30, further comprising a step of combining said hybrid solid electrolyte particulates, particles of an anode active material, and a conductive additive into an anode electrode; or combining said hybrid solid electrolyte particulates, particles of a cathode active material, and a conductive additive into a cathode electrode.

34. The process of claim 30, further comprising a step of combining and consolidating said hybrid solid electrolyte particulates to form a solid electrolyte separator.

35. A process for producing a plurality of the hybrid solid electrolyte particulates as defined in claim 1, said process comprising:
a) dispersing a plurality of primary particles of an inorganic solid electrolyte, having a diameter or thickness from 1 nm to 20 μm, in a liquid solution, comprising a polymer dispersed in a liquid solvent, to form a slurry;
b) forming the slurry into micro-droplets; and
c) removing the liquid solvent in said micro-droplets to form the hybrid solid electrolyte particulates.

36. The process of claim 35, wherein said step (B) of forming micro-droplets comprises a procedure selected from pan-coating, air-suspension coating, centrifugal extrusion, vibration-nozzle encapsulation, spray-drying, extrusion and palletization, kneadering, or a combination thereof.

37. The process of claim 35, further comprising a step of combining and consolidating said hybrid solid electrolyte particulates to form a solid electrolyte separator.

38. The process of claim 30, further comprising a step of combining and consolidating (i) said hybrid solid electrolyte particulates having a 1^{st} solid electrolyte polymer encapsulating inorganic solid electrolyte particles and (ii) anode or cathode active material particles encapsulated by a 2^{nd} solid electrolyte polymer to form an anode or cathode electrode, wherein the 1^{st} solid electrolyte polymer and the 2^{nd} solid electrolyte polymer are identical or different in chemical composition or structure.

39. The process of claim 35, further comprising a step of combining and consolidating (i) said hybrid solid electrolyte particulates having a 1^{st} solid electrolyte polymer encapsulating inorganic solid electrolyte particles and (ii) anode or cathode active material particles encapsulated by a 2^{nd} solid electrolyte polymer to form an anode or cathode electrode, wherein the 1^{st} solid electrolyte polymer and the 2^{nd} solid electrolyte polymer are identical or different in chemical composition or structure.

40. The process of claim 38, further including a conductive additive that is combined and consolidated with said hybrid solid electrolyte particulates and said anode or cathode active material particles encapsulated by said 2^{nd} solid electrolyte polymer to form said anode or cathode electrode.

41. The process of claim 39, further including a conductive additive that is combined and consolidated with said hybrid solid electrolyte particulates and said anode or cathode active material particles encapsulated by said 2^{nd} solid electrolyte polymer to form said anode or cathode electrode.
